(19) United States
(12) Patent Application Publication
(10) Pub. No.: US 2019/0191657 A1
(43) Pub. Date: Jun. 27, 2019

(54) A TEST DEVICE AND TEST METHOD FOR A MILKING MACHINE

(71) Applicant: DELAVAL HOLDING AB, Tumba (SE)

(72) Inventor: Jörgen ENICKL, Tumba (SE)

(73) Assignee: DELAVAL HOLDING AB, Tumba (SE)

(21) Appl. No.: 16/325,526

(22) PCT Filed: Sep. 4, 2017
(86) PCT No.: PCT/SE2017/050875

§ 371 Date: Feb. 14, 2019

(30) Foreign Application Priority Data
Sep. 5, 2016 (SE) 1651191-7

(51) Int. Cl. A01J 5/007; G01F 25/00; G05D 7/06; A01J 7/00

(52) U.S. Cl. CPC A01J 5/007; A01J 7/00; G05D 7/0635; G01F 25/0053

(57) ABSTRACT

A test device includes a fluid flow conduit, an air flow regulator, a pressure sensor, an air flow meter, and a control unit automatically controlling the air flow regulator on basis of a measurement performed by the pressure sensor or the air flow meter; controlling the air flow regulator and the pressure sensor or the air flow meter such that a closed loop sequence in which either the measured pressure or the measured air flow rate is used as the basis for changing the air flow rate by control of the air flow regulator until the moment in which the measured pressure or measured air flow rate reaches a predetermined value; and automatically initiating measurement operation of the other one of the pressure sensor or air flow meter when the measured pressure or measured air flow rate measured in the closed loop reaches the predetermined value.

### TECHNICAL FIELD

The present invention relates to a test device configured to test a milking machine, said test device comprising: a fluid flow conduit, an air flow regulator arranged to regulate the air flow in the fluid flow conduit, a pressure sensor arranged to measure the pressure in the fluid flow conduit and an air flow meter arranged to measure the air flow rate in the fluid flow conduit, wherein the fluid flow conduit is arranged to be connected to a vacuum pump of a milking machine during testing of said milking machine by means of the test device, such that a pressure is generated in the fluid flow conduit by the action of the vacuum pump.

The present invention also relates to a a method of testing a milking machine, comprising the steps of: setting one of a predetermined pressure and a predetermined air flow to be obtained in a fluid flow conduit connected to a vacuum pump of the milking machine, measuring one of the pressure or the air flow in the fluid flow conduit and regulating the air flow rate in the fluid flow conduit until said one of the predetermined pressure and predetermined air flow rate is obtained in the fluid flow conduit as a result of said regulation.

### BACKGROUND AND PRIOR ART

Contemporary milking machines for extracting milk from cows, buffaloes, goats, sheep and the like comprise a plurality of components, such as fluid flow conduits, vacuum pumps, valves, teat cups, milk receiver tanks etc. During a milking operation, a vacuum pump of the milking machine is arranged to generate a predetermined vacuum at a so called milking point, which is the interface between the teats of the animal and the milking machine during milking. The vacuum at the milking point should neither be too high nor too low and should be sufficient to generate a flow of milk through the milk line from the milking point to a milk receiver tank.

There should be no unknown or non-acceptable leakages in the milk line and there should be no unknown or non-acceptable obstacles in the milk line.

To establish that there are no obstacles, tests of the milking machine are conducted, which include air flow measurements and pressure measurements, wherein high air flow rates are permitted through the milk line.

Milking machines need to be regularly tested with regard to vacuum levels and air flow rate levels. During such testing, an operator will normally use a test device that is configured to measure an air flow rate through a fluid flow conduit of the milking machine at a certain point of the milk line, preferably in the region of the milking point, which point may be just downstream and adjacent the teat cups of a milking machine.

It is requested that testing of the milking machine requires a minimum of time in order to minimize hold times of the milking machine, i.e. when the machine cannot be used for milking, and that the testing yet is correct and precise.

During one type of tests that have as their purpose to detect reduced air flow capacity of the milk line, the vacuum pump is set on its operation output, i.e. as during normal milking operation, an air flow meter comprising an air flow regulator and a pressure sensor is positioned in the milk line adjacent the milking point. By means of the pressure sensor a reference pressure downstream the air flow regulator is measured with the air flow regulator in a fully closed state. On the opposite, upstream side of the air flow regulator there is atmospheric pressure. The air flow regulator may comprise discs with different hole patterns therein, and the different hole patterns correspond to different air flow rates. By manual setting of the air flow regulator (by selection and combination of hole patterns and thereby the restriction level) the air flow rate can be increased until a predetermined pressure, which is thus lower than the initially measured reference pressure, is measured by means of the pressure sensor. According to one test procedure the air flow rate should be reduced by means of the air fluid regulator until a target pressure that is 5 kPa lower than the reference pressure is registered by means of the pressure sensor. When this condition is met, an operator reads, on a scale on the air flow regulator, which air flow rate that can be assumed for the specific chosen hole pattern that results in the requested target pressure. In other words, this is not a direct but an indirect measurement of air flow rate.

The correlation between air flow rate and pressure for the respective restriction levels of the air flow regulator of this type is based on the presumption that the atmospheric pressure has a predetermined value (for example 1,013 bar) and that there is a predetermined temperature (typically 20° C.). This technique has several drawbacks. For example, it does not take into consideration the effects of differences in atmospheric pressure and temperature on the air flow rate, the incremental steps by which the air regulator is opened are rather large, and it requires manual setting of the restriction level, as well as reading of correlation tables by the operator in order to find out the air flow rate.

In some tests a so called rotatmeter issued, especially when the flow rate is low, for direct measurement of the air flow rate. A rotameter basically comprises a tube and a floating body. The float responds linearly to changes in the volume flow through the meter, and the operator reads the float level occularly. A drawback of rotameters is that they do not take into consideration the effects of air humidity and temperature on the density of the air. Thus, a measurement with such an air flow meter may result in false information regarding the actual air mass flow, and thereby the flow capacity of milk line. Moreover, since the float position is gravity dependent, rotameters must be oriented and mounted vertically, and this may be difficult to achieve for the operator on site. The operator himself or herself must also be in a correct position when reading the float level, and there may be fluctuations of the float level due to fluctuations in the vacuum level that further complicates the reading of the float level. All these parameters contribute to a somewhat uncertain measuring result being obtained.

It is thus an object of the present invention to present an alternative device and method for testing a milking machine, which is more accurate than prior art used so far in the present field of art, and which requires less interaction by an operator and is therefore less dependent on measures taken by the operator.

### SUMMARY OF THE INVENTION

The object of the present invention is achieved by means of the initially defined device, which is characterised in that the test device comprises a control unit configured to control the operation of the air flow regulator and thereby regulate the air flow rate in the fluid flow conduit on basis of the measurement performed by said one of the pressure sensor and the air flow meter, that the control unit is configured to control the operation of the air flow regulator and said one of the pressure sensor and the air flow meter such that a closed loop is conducted in which either the measured pressure or the measured air flow rate is used as the basis for changing the air flow rate by control of the air flow regulator until the moment in which the measured pressure or measured air flow rate reaches a predetermined value, and that the control unit is arranged to initiate measurement operation of the other one of said pressure sensor and air flow meter when said measured pressure or measured air flow rate measured in said closed loop reaches the predetermined value.

The control unit is either integrated as a part of single unit formed by the device, or forms a separate part. The control unit may be connected by wire or wirelessly to the air flow regulator, the pressure sensor and the air flow meter. The control unit comprises or is connected to software which is stored on hardware and designed to control the operation of the air flow regulator on basis of data input that it receives from the pressure sensor or the air flow meter.

According to one embodiment said one of the pressure sensor and the air flow meter is arranged to perform its measurements in said closed loop with a frequency of at least 10 Hz, preferably at least 100 Hz. According to certain embodiments, the measurement frequency is even higher, preferably at least 1000 Hz. A higher measurement frequency will contribute to a rapid and exact approaching towards said predetermined value.

According to one embodiment, said control unit comprises a user interface which enables a user to set said predetermined pressure or predetermined air flow rate that is to be obtained by means of regulation of air flow by means of the air flow regulator. According to one embodiment, said predetermined pressure and/or air flow rate is preprogrammed into software comprised by the control unit. However, a possibility for an operator to change the targeted predetermined pressure or air flow rate will increase the usability of the test device and the possibility to apply different test procedures by means thereof.

According to one embodiment, said user interface comprises a display screen arranged to display pressure measured by the pressure sensor and air flow rate measured by the air flow meter. Preferably, the presentation of the measured values is a digital presentation, thereby reducing the risk of erroneous reading of pressure or air flow rate by the operator, as in the case of rotameters of prior art.

According to one embodiment, the air flow regulator is arranged to control the air flow rate by regulating a cross-sectional area of a part of the fluid flow conduit, either incrementally in a plurality of incremental steps or steplessly. The air flow regulator may comprise any kind of suitable controllable member able of restricting the cross-sectional area of a channel through which the air flows. For example it may be comprise any kind of controllable valve or a disc or the like arranged to perform a motion across said channel and thereby restrict the latter.

According to one embodiment, the fluid flow conduit is at least partly formed by a flexible hose and that the air flow regulator comprises a squeezing element arranged to squeeze the hose in order to reduce the air flow rate through the hose. The squeezing element is driven by an electric motor the operation of which, in its turn, is controlled by the control unit. It has been found that, by squeezing a hose, a non-turbulent, and therefore advantageous, air flow is obtained in the fluid flow conduit.

According to one embodiment, the test device is provided with a connection means for connection thereof to a teat cup of a milking machine or to a milk line conduit of a milking machine. Preferably, in order to avoid operations in which there is a risk of disturbing or in any other way affecting the function of the milk line, the means for connection is configured to be attached to the teat cup of a milking cluster of a milking machine. The connection means may have the shape of a teat and be designed to be introduced into a teat cup from an upstream direction, just like an animals teat will during milking. The connection member is designed such that it forms a tight sealing against the part of the milking machine to which it is connected, to avoid unwanted leakage of air into the fluid flow conduit of the milking machine to which the fluid flow conduit of the test device is connected and which is in fluid communication with the vacuum pump of the milking machine. One end of said fluid flow conduit of the test device is included in said connection member. Another end of said fluid flow conduit is preferably configured to communicate directly with and form an interface towards the atmosphere.

According to one embodiment, the device is arranged such that, when it is connected to a milking machine for testing, upstream the air flow regulator there is atmospheric pressure and downstream the air flow regulator there is a pressure generated by said vacuum pump of the milking machine.

According to one embodiment, the air flow meter is a air mass flow meter. Thereby, consideration is taken to air humidity as well as temperature, and a correct air mass flow value is obtained.

The object of the invention is also achieved by the initially mentioned method, which is characterised in that
the regulation of the air flow rate is controlled by a control unit which receives input from one of a pressure sensor and an air flow meter provided in the fluid flow conduit and that the control unit controls the operation of an air flow regulator on basis of said input,
wherein a closed loop is controlled by the control unit, in which loop either the measured pressure or the measured air flow rate is used as the basis for changing the air flow rate by control of the air flow regulator until the moment in which the measured pressure or measured air flow rate reaches a predetermined value, and in that,
when said predetermined value has been reached, the other one of the pressure and the air flow rate in the fluid flow conduit is measured.

The closed loop in which the pressure or the air flow rate is measured and the air flow rate is regulated on basis thereof by means of an air flow regulator is an automatic sequence, in which the control unit is used for controlling the air flow regulator on basis of the measurement data received from a pressure sensor or air flow meter. The final step of measuring the other one of the pressure and the air flow rate when said predetermined pressure or air flow rate has been reached could either be initiated by manual interaction by an operator, or, preferably, automatically through the action of the control unit which then orders such measurement from the pressure sensor or air flow meter respectively. Preferably, said method is performed by means of a device according to the present invention, as disclosed hereinabove.

According to one embodiment, and for reasons already mentioned, the measurements of pressure or air flow rate in said cosed loop are conducted with a frequency of at least 10 Hz, preferably at least 100 Hz. According to one embodiment, the measurement frequency is at least 1000 Hz.

According to one embodiment, the pressure measurement is performed in a milk line in the region of or close to a milking point of the milking machine. According to one embodiment, the air flow measurement is performed in a milk line in the region of or close to a milking point of the milking machine. Preferably, the measurements of pressure and air flow rate of the method are performed by means of a test device as defined hereinabove or hereinafter, which is inserted into a teat cup of a milking machine from a position upstream the teat cup with regard to the milk flow direction in the milking machine. Thereby, a minimum of engagement is need in the milk line.

According to one embodiment, the regulation of the air flow in the fluid flow conduit is performed by regulating a cross-sectional area of a part of the fluid flow conduit, either incrementally in a plurality of incremental steps or steplessly. Thereby, a very fine tuning of the pressure or air flow rate can be achieved when performing the loop in which either the measured pressure or the measured air flow rate is used as a basis for controlling and the air flow regulator.

According to one embodiment, the air flow is regulated by squeezing a flexible hose that forms at least a part of said fluid flow conduit.

According to a preferred embodiment, the air flow rate is measured by measuring the mass of the air flowing through the fluid flow conduit.

Further features and advantages of the device and method of the present invention will be presented in the following detailed description.

### BRIEF DESCRIPTION OF THE DRAWINGS

Embodiments of the present invention will be described more in detail with reference to the annexed drawing, on which:

FIG. 1 is a schematic representation of a test device according to the invention, and

FIG. 2 is a schematic representation of a milking machine provided with a test device according to the invention.

### DETAILED DESCRIPTION

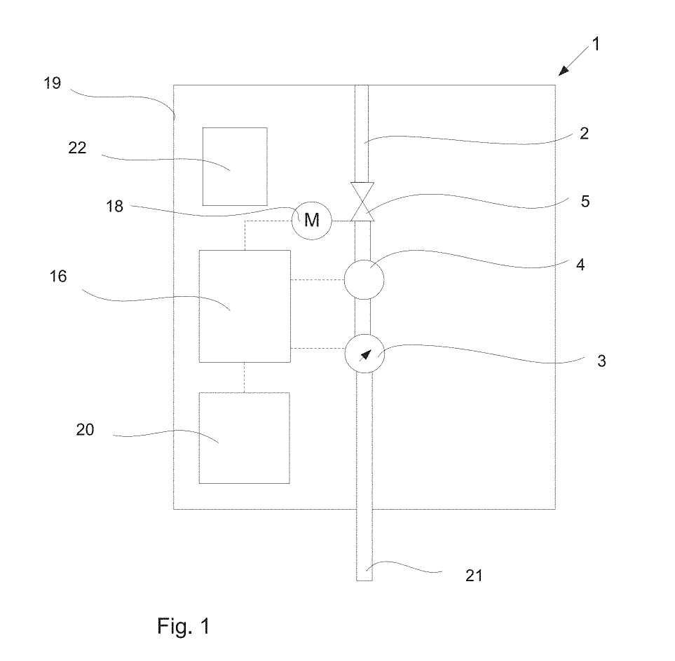

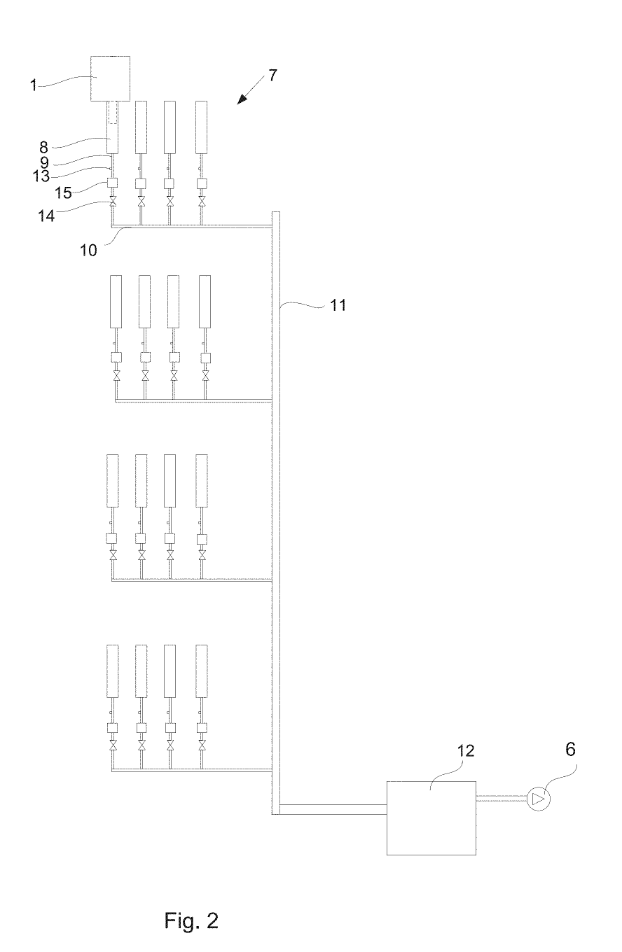

FIG. 1 shows a test device 1 according to the invention. The test device 1 is configured for testing the condition of a milking machine, parts of which are shown in FIG. 2, for industrial milking of animals, typically cows.

The test device 1 comprises a fluid flow conduit 2, a pressure sensor 3 arranged to measure the pressure in the fluid flow conduit 2, an air flow meter 4 arranged to measure the air flow rate in the fluid flow conduit 2, and an air flow regulator 5 arranged to regulate the air flow in the fluid flow conduit 2, wherein the fluid flow conduit 2 is arranged to be connected to a vacuum pump (denoted 6 in FIG. 2) of a milking machine during testing of said milking machine by means of the test device 1, such that a pressure is generated in the fluid flow conduit 2 by the action of the vacuum pump 6.

Before further describing the test device 1, a description of a typical milking machine to be tested by means of the test device should be given. It should be understood that this is only one out of a number different milking machine designs on which the test device is applicable. Essential parts of such a milking machine are shown in FIG. 2. The milking machine comprises at least one milking place 7 arranged to house one animal at a time. Each milking place comprises one or more teat cups 8. In FIG. 2 only four milking places are shown, but it should be understood that a smaller or larger number of milking places may be provided. From each teat cup 8 a fluid flow conduit 9 extends to a common fluid flow conduit 10, which, in its turn, leads to or form part of a main fluid flow conduit 11. The main fluid flow conduit 11 leads to a milk receiver 12. The vacuum pump 6 is also in fluid communication with said milk receiver, and thereby in fluid communication with each teat cup 8 through the fluid flow conduits 9-011 mentioned. The mentioned fluid flow conduits 9, common fluid flow conduit 10 and main fluid flow conduit 11 together form part of a milk line from the teat cup 8 to the milk receiver 12. In the fluid flow conduit 9 extending from each teat cup 8, there is provided an air inlet hole 13 and a shut-off valve 14. In each fluid flow conduit 9, upstream the shut-off valve 14 as seen in the conceived milk flow direction from the respective teat cup 8, there is provided a milk meter 15 for measuring milking rate and quantity from the respective teat cup 8. Further components may, of course, be provided in the milk line of the milking machine but are not shown in FIG. 2. In FIG. 2 so called garter milking is shown, but is to be noted that, as an alternative design, the teat cups may be connected to a so called claw to form a so called milking cluster. When a milking cluster design is used, there is only provided one common shut-off valve and one common milk meter downstream the four teat cups of a single milking place.

The vacuum pump 6 is arranged to generate a system pressure within a predetermined range, typically approximately 45 kPa. During milking, the teats of an animal are adopted by the teat cups 8. The interface between the teats of the animal and the milking machine during milking may be referred to as the milking point. The vacuum at the milking point should neither be too high nor too low and should be sufficient to generate a flow of milk through the milk line from the milking point to the milk receiver 12 during milking. For most cow populations a milking point pressure within the range of 32-42 kPa is preferred. The transportation of milk is thus vacuum-driven. However, a certain air flow is also needed, and achieved by the provision of the air inlet holes 13 provided downstream the teat cups 8 as seen in the milk transportation direction.

FIG. 1 is once again referred to for a further description of the test device 1. Apart from the components already mentioned, the test device also comprises a control unit 16 for controlling the operation of the air flow regulator 5 on basis of a measurement performed by one of the pressure sensor 3 and the air flow meter 4, wherein the control unit 16 is connected to the air flow regulator 5, the pressure sensor 3 and the air flow meter 4. Through the control unit 16 one of the pressure sensor 3 and the air flow meter 4 is connected to the air flow regulator 5. Thereby, the air flow regulator 5 is arranged to regulate the flow through the fluid flow conduit 2 of the test device 1 on basis of the result of a measurement performed by said one of the pressure sensor 3 and the air flow meter 4 until a predetermined pressure or a predetermined air flow is measured by said one of the pressure sensor 3 and the air flow meter 4. When said predetermined pressure or predetermined air flow rate is obtained as a result of the air flow regulation by the air flow regulator 5, the other one of said pressure sensor 3 and air flow meter 4 is arranged to measure the corresponding pressure and air flow rate respectively. The measurement frequency during the closed loop in which the air flow regulator is controlled on basis of pressure measurement of air flow rate measurement is preferably higher than 100 Hz, even more preferably higher than 1000 Hz.

The air flow meter 4 is an air mass flow meter. An air mass flow meter may be referred to as an inertial flow meter and is a device that measures mass flow rate of a fluid traveling through a tube. The air mass flow rate is the mass of the fluid traveling past a fixed point per unit time. The air mass flow meter does not measure the volume per unit time (e.g., cubic meters per second) passing through the device; it measures the mass per unit time (e.g., kilograms per second) flowing through the device.

The air flow regulator 5 is arranged to control the air flow by regulating a cross-sectional area of a part of the fluid flow conduit 2, either incrementally in a plurality of incremental steps or steplessly. The air flow regulator 5 may comprise any kind of suitable controllable member able of restricting the cross-sectional area of a channel through which the air flows. Here, the fluid flow conduit 2 is at least partly formed by a flexible hose and the air flow regulator 5 comprises a squeezing element arranged to squeeze the hose in order to reduce air flow rate through the hose. The squeezing element is driven by an electric motor 18 the operation of which, in its turn, is controlled by the control unit 16. It has been found that, by squeezing a hose, a non-turbulent, and therefore advantageous, air flow is obtained in the fluid flow conduit 2.

The test device 1 comprises a casing 19 and is designed as one single unit. The control unit 16 is connected by wire or wirelessly to the air flow regulator 5, the pressure sensor 3 and the air flow meter 4 and housed together with these components in the casing 19. The control unit 16 comprises or is connected to software which is stored on hardware and designed to control the operation of the air flow regulator 5 on basis of data input that it receives from the pressure sensor 3 or the air flow meter 4.

Said software is designed to order the air flow meter 4 to perform a measurement of the air flow rate when a predetermined pressure has been registered by the pressure sensor 3 as consequence of the control of the air flow regulator, or to order the pressure sensor 3 to perform a measurement of the pressure when a predetermined air flow rate has been registered by the air flow meter 4, depending on which of the two alternative principles that is applied. The control unit 16 could also be arranged so as to enable an operator to choose between these two principles and to operate according to either of them depending on which is chosen.

The control unit comprises a user interface 20 visible from outside the casing 19, which, according to one embodiment, enables an operator to set said predetermined pressure or predetermined air flow rate that is to be obtained by means of regulation of air flow by means of the air flow regulator 5. Here, said user interface 20 comprises a display screen arranged to display pressure measured by the pressure sensor 3 and air flow rate measured by the air flow meter 4.

The test device 1 is provided with a connection means 21 for connection thereof to a teat cup 8. For that purpose the connection means 21 may have the shape of a teat and be designed to be introduced into a teat cup 8 from an upstream direction (as seen in the milk flow direction), just like an animals teat will during milking. The connection member 21 is designed such that it forms a tight sealing against the part of the milking machine to which it is connected, to avoid unwanted leakage of air into the fluid flow conduit 9 of the milking machine to which the fluid flow conduit 2 of the test device is connected and which is in fluid communication with the vacuum pump 6 of the milking machine. In the exemplifying embodiment presented in FIG. 1, the connection member 21 formed by a prolongation of the fluid flow conduit 2 of the test device 1 extends out of the casing 19. The opposite end of the fluid flow conduit 2 of the test device 1 is thereby configured to be an open interface to the ambient atmosphere. As an alternative to connection to a teat cup from the upstream end thereof, the test device could also be designed so as to be connected to any other part of the milk line formed the fluid flow conduits 9, 10, 11 of the milking machine. Then, opposite ends of the fluid flow conduit 2 of the test device 1 should be designed to be connected to connections, for example predetermined nipples or the like, of said fluid flow conduits 9, 10, 11 of the milking machine.

The test device may also comprise a battery 22 housed in the casing 19, said battery being connected to the control unit and the motor 18 for driving the air flow regulator 5. The battery 22 may be connected to any power consuming component in the test device 1 in order to make the use of the test device independent of access to an electric grid.

The test device is used and operates in the following way. The connection means 21 is connected to a predetermined connection of the milking machine. In this embodiment, this means to a teat cup 8. The remaining teat cups are either sealingly plugged from outside or shut off from communication with the rest of the milk line by closure of their respective shut off valve 9. These steps may be taken by an operator. If the air flow rate is to be controlled on basis of measurement of the measured pressure, the control unit 16 initiates a first measurement step in which a reference pressure is measured by the pressure sensor 3, with the air flow regulator 5 in a closed position in which no air is conducted through the latter. This pressure corresponds to the system pressure generated by the vacuum pump 6 minus losses in the system.

The software of the control unit 16 is either preprogrammed with a predetermined pressure value to be achieved by opening of the air flow regulator 5 to a certain level, or can be provided with such a value by the operator via the user interface 20. According to one test method, the predetermined pressure to be reached is the reference pressure minus a predetermined pressure, for example the reference pressure minus 5 kPa. The control unit 16 then starts a closed loop sequence in which the pressure is measured by the pressure sensor 3, the measured pressure value is transmitted as input to the control unit 16, the control unit compares the pressure value with the predetermined pressure to be reached and transmits a control signal to the air flow regulator 5 to incrementally increase the air flow rate through the fluid flow conduit 2. The loop continues until the predetermined pressure is reached. A measuring frequency of above 100 Hz, preferably above 1000 Hz is applied. The size of the incremental change of the air flow rate caused by the air flow regulator should be adapted to the chosen measuring frequency, such that the pressure could be expected to be within the predetermined range within a reasonably short time, preferably a few seconds. Yet the size of the incremental change should be small enough to guarantee a very precise adjustment of the pressure.

Once the measured pressure is reached the the control unit 16 stops the closed loop and initiates a measurement of the air flow rate by the air flow meter 4. Finally, the measured final pressure, which should be said predetermined pressure, and the measured air flow rate is presented to the operator on the user interface/display screen 20. Typically, this test procedure is used for the purpose of determining whether there is any obstacles in the milking machine that results in an insufficient fluid flow capability of the milking machine. Accordingly if the measured air flow rate is too low or outside a predetermined preferred range, this could be an indication that there is some deficiency or obstacle in the milk line, or that any of the components of the milking machined should be tuned or repaired in order to enable the requested air flow rate to be obtained at the predetermined pressure. Depending on type of milking machine and application, different minimum air flow rates are set. For milking machines aimed for cows and with a system pressure of 45 kPa and a milking point pressure of 32-42 kPa, a minimum air flow rate could, for example, be 75 liters per minute.

As an alternative to the above procedure, the control of the air flow regulator 5 is based on a measured air flow rate range instead of a measured pressure. Thereby, the closed loop controlled by the control unit 16 is a closed loop in which the air flow regulator is controlled on basis of air flow rate measurements by the air flow meter 4. The test procedure could, nonetheless, start as in the above-described test procedure. Accordingly, the control unit 16 initates a first measurement step in which a reference pressure is measured by the pressure sensor 3, with the air flow regulator 5 in a closed position in which no air is conducted through the latter. After that, the control unit 16 initiates a second measurement step in which the air flow rate is measured by the air flow meter and the air flow is regulated by the air flow regulator on basis of the measured air flow rate until a predetermined air flow rate is achieved. In other word, a closed loop is conducted under the control of the control unit 16 until a predetermined air flow rate is achieved. Then pressure is measured, presented and can be compared to a predetermined pressure that should have been reached at that air flow rate. Deviations from the requested predetermined pressure could be taken as evidence of obstacles or other deficiencies in the milking machine.

The test device of the present invention could of course also be used for the purpose of othet test procedures than the ones described hereinabove. In all kinds of measurements in which there is a need of controlling the milking system such that a predetermined pressure or a predetermined air or gas flow rate is achieved, and to know both the pressure and the air/gas flow rate at that point, the test device of the invention can provide a rapid and very precise measurement and control tool.

1. A test device configured to test a milking machine, said test device comprising:
a casing (19);
a fluid flow conduit (2) located within the casing (19), the fluid flow conduit (2) having a first end and an opposite, second end;
a connection part (21) that connects to one of a teat cup of the milking machine and a milk line conduit of the milking machine, the connection part (21) extending to the casing (19) and connecting to the first end of the fluid flow conduit (2) such that, during testing of the milking machine by the test device, a pressure is generated in the fluid flow conduit (2) by action of a vacuum pump (6) of the milking machine;
an air flow regulator (5) operatively connected to the fluid flow conduit (2) and arranged to regulate the air flow in the fluid flow conduit (2), the air flow regulator (5) being located within the casing (19);
a pressure sensor (3) operatively connected to the fluid flow conduit (2) and arranged to measure a pressure in the fluid flow conduit (2), the pressure sensor (3) being located within the casing (19);
an air flow meter (4) operatively connected to the fluid flow conduit (2) and arranged to measure an air flow rate in the fluid flow conduit (2), the air flow meter (4) being located within the casing (19); and
a control unit (16) located within the casing (19) and operatively connected to the air flow regulator (5), the pressure sensor (3), and the air flow meter (4), the control unit (16) configured to control operation of the air flow regulator (5) and thereby regulate the air flow rate in the fluid flow conduit (2) on basis of a measurement performed by one of the pressure sensor (3) and the air flow meter (4),
wherein the control unit (16) is configured to automatically control the operation of the air flow regulator (5) and said one of the pressure sensor (3) and the air flow meter (4) such that an automated closed loop sequence of measurement and control is conducted in which one of the measured pressure in the fluid flow conduit (2) and the measured air flow rate in the fluid flow conduit (2) is transmitted to the control unit (6) and used as an input to the control unit (16) as a basis for changing the air flow rate by control of the air flow regulator (5), the closed loop sequence of measurement and control continuing until a moment in which the one of the measured pressure and the measured air flow rate in the fluid flow conduit (2) reaches a predetermined value, and
wherein, once one of the measured pressure and the measured air flow rate, measured as part of said closed loop sequence, reaches the predetermined value, the control unit (16) is arranged to initiate a measurement operation of the other one of said pressure sensor (3) and the air flow meter (4) and provide a result of the measurement operation of the other one of said pressure sensor (3) and the air flow meter (4).

2. The test device according to claim 1, wherein, in the closed loop sequence of measurement and control, the control unit (16) is configured to control said one of the pressure sensor (3) and the air flow meter (4) to perform the measurements during said closed loop sequence with a frequency of at least 10 Hz.

3. The test device according to claim 1, wherein said control unit (16) comprises a user interface (20) which enables a user to set said predetermined value of the measured pressure or the measured air flow rate that is to be obtained by regulation of air flow by the air flow regulator (5) during the closed loop sequence of measurement and control.

4. The test device according to claim 3, wherein said user interface (20) comprises a display screen arranged to display the result of the measurement operation of the other one of the pressure sensor (3) and the air flow meter (4).

5. The test device according to claim 1, wherein the air flow regulator (5) is arranged to control the air flow rate by regulating a cross-sectional area of a part of the fluid flow conduit (2).

6. The test device according to claim 1, wherein the fluid flow conduit (2) is at least partly formed by a flexible hose and the air flow regulator (5) comprises a squeezing element arranged to squeeze the hose in order to reduce the air flow rate through the flexible hose.

7. The test device according to claim 1, wherein the connection part (21) has a teat shape for introduction into the teat cup (8) from an upstream direction, as seen in a milk flow direction, to thereby form a sealing against an interior of the teat cup (8).

8. The test device according to claim 7, wherein the device is arranged such that, when connected to the milking machine for testing, upstream the air flow regulator (5) there is atmospheric pressure and downstream the air flow regulator (5) there is the pressure generated by said vacuum pump (6) of the milking machine.

9. The test device according to claim 1, wherein the air flow meter (4) is a mass flow meter.

10. A method of testing a milking machine, comprising the steps of:
setting a predetermined value of one of a predetermined pressure and a predetermined air flow to be obtained in a fluid flow conduit (2) connected to a vacuum pump (6) of the milking machine,
automatically conducting a closed loop sequence of measurement and control by repeatedly measuring one of a pressure and an air flow in the fluid flow conduit (2) and, based on the measured one of the pressure and the air flow in the fluid flow conduit (2), automatically regulating the air flow in the fluid flow conduit (2) until said value of the one of the predetermined pressure and the predetermined air flow rate is obtained in the fluid flow conduit (2) as a result of said regulation during the closed loop sequence of measurement and control,
wherein the regulation of the air flow rate is controlled by a control unit (16) which receives the measured one of the pressure and the air flow in the fluid flow conduit (2) as input from one of a pressure sensor (3) and an air flow meter (4) provided in the fluid flow conduit (2) and the control unit controls the operation of an air flow regulator (5) on basis of said input,
wherein the closed loop sequence of measurement and control is automatically repeated and controlled by the control unit (16), where the measured one of the pressure and the air flow in the fluid flow conduit (2) is used as the basis for changing the air flow rate by control of an air flow regulator (5) until a moment in which the measured pressure or the measured air flow rate reaches the predetermined value, and
wherein when said predetermined value has been reached, the other one of the pressure and the air flow rate in the fluid flow conduit (2) is measured under control of the control unit (16) and used as an indication of whether an obstacle or deficiency in the milking machine is resulting in an insufficient fluid flow capability of the milking machine.

11. The method according to claim 10, wherein the control unit (6) controls the measurements of pressure or air flow rate in said closed loop sequence to be conducted with a frequency of at least 10 Hz.

12. The method according to claim 10, wherein the pressure measurement is performed in a milk line in a region of a milking point of the milking machine.

13. The method according to claim 10, wherein the air flow measurement is performed in a milk line in the region of a milking point of the milking machine.

14. The method according to claim 10, wherein the regulation of the air flow in the fluid flow conduit (2) is performed by regulating a cross-sectional area of a part of the fluid flow conduit (2).

15. The method according to claim 10, wherein the air flow is regulated by squeezing a flexible hose that forms at least a part of said fluid flow conduit (2).

16. The method according to claim 10, wherein the air flow rate is measured by measuring the mass of the air flowing through the fluid flow conduit (2).

17. The test device according to claim 1, wherein,
the connection part (21) is connectable to a fluid flow conduit of the milk line conduit of the milking machine, and
the second end of the fluid flow conduit (2) is also being connectable to the fluid flow conduit the milk line conduit of the milking machine.

18. The test device according to claim 1, wherein,
the connection part (21) has a teat shape for introduction introduced into the teat cup (8) from an upstream direction, as seen in a milk flow direction, to thereby form a sealing against an interior of the teat cup (8), and
the second end of the fluid flow conduit (2) includes an open interface to ambient atmosphere.

19. The test device according to claim 18, wherein,
the control unit (16) is configured to automatically control the operation of the air flow regulator (5) and the pressure sensor (3) such that the closed loop sequence of measurement and control is conducted in which the measured pressure in the fluid flow conduit (2) is used as the input to the control unit (16) as the basis for changing the air flow rate by control of the air flow regulator (5),
the closed loop sequence of measurement and control continuing until the moment in which the measured in the fluid flow conduit (2) reaches the predetermined value, and
once said measured pressure, measured as part of said closed loop sequence, reaches the predetermined value, the control unit (16) is arranged to initiate the measurement operation of the air flow meter (4) and output the result of the measurement operation of the air flow meter (4), the result being an indication of whether an obstacle or deficiency in the milking machine is resulting in an insufficient fluid flow capability of the milking machine.

20. The test device according to claim 18, wherein,
the control unit (16) is configured to automatically control the operation of the air flow regulator (5) and the air flow meter (4) such that the closed loop sequence of measurement and control is conducted in which the measured air flow rate in the fluid flow conduit (2) is used as the input to the control unit (16) as the basis for changing the air flow rate by control of the air flow regulator (5),
the closed loop sequence of measurement and control continuing until a moment in which the measured air flow rate in the fluid flow conduit (2) reaches the predetermined value, and
once the measured air flow rate, measured as part of said closed loop sequence, reaches the predetermined value, the control unit (16) is arranged to initiate the measurement operation of the pressure sensor (3) and output the result of the measurement operation of the pressure sensor (3), the result being an indication of whether an obstacle or deficiency in the milking machine is resulting in an insufficient fluid flow capability of the milking machine.

21. The test device according to claim 1, wherein, in the closed loop sequence of measurement and control, the control unit (16) is configured to control said one of the pressure sensor (3) and the air flow meter (4) to perform the measurements during said closed loop sequence with a frequency of at least 100 Hz.

22. The test device according to claim 1, wherein, in the closed loop sequence of measurement and control, the control unit (16) is configured to control said one of the pressure sensor (3) and the air flow meter (4) to perform the measurements during said closed loop sequence with a frequency of at least 1000 Hz.
